(19) United States
(12) Patent Application Publication
(10) Pub. No.: US 2004/0091407 A1
(43) Pub. Date: May 13, 2004

(54) Novel process for preparing crystalline particles

(76) Inventors: Robert William Lancaster, Stevenage (GB); Hardev Singh, Dartford (GB); Andrew Lewis Theophilus, Stevenage (GB)

Correspondence Address: DAVID J LEVY, CORPORATE INTELLECTUAL PROPERTY, GLAXOSMITHKLINE, FIVE MOORE DR., PO BOX 13398, RESEARCH TRIANGLE PARK, NC, 27709-3398, US

(21) Appl. No.: 10/312,433

(22) PCT Filed: Jun. 29, 2001
(86) PCT No.: PCT/GB01/02936

(30) Foreign Application Priority Data
Jun. 29, 2000 (GB) 0016002.8

(51) Int. Cl. B01D 9/00

(52) U.S. Cl. 422/245.1

(57) ABSTRACT

The present invention relates to a novel process for preparing crystalline particles of a salt of a substance, particularly particles of therapeutically useful or carrier substances of a size suitable for inhalation therapy.

This invention relates to a novel process for preparing crystalline particles, particularly particles of defined particle size distribution, especially particles of therapeutically useful or carrier substances of a size suitable for inhalation therapy.

Industrial processes for production of many products, particularly pharmaceutical products, require the preparation of pure substances of a defined particle size distribution. Pure substances are frequently prepared by precipitation from solutions of lesser purity. When precipitation takes place relatively slowly (e.g. over a matter of hours), crystals are grown which are frequently of a non-uniform shape and relatively large size.

In the field of inhalation therapy, therapeutic molecules are generally desired of a particle size “suitable for inhalation”, which is a term generally taken to indicate an aerodynamic diameter between 1 and 10 μm, especially 1 and 5 μm, particularly 1 and 3 μm. Carrier molecules (such as lactose) for inhaled therapeutic preparations are typically desired of a significantly larger aerodynamic diameter so that they do not penetrate into the upper respiratory tract to the same degree as the active ingredient and an aerodynamic diameter of 100 to 150 μm is generally considered suitable. However this is a generalisation and for some purposes it may well be preferred to use a lower particle size for the carrier, even one comparable to that of the therapeutic substance.

Outside of the inhaled area, modification of the habit and size of crystals is a valuable tool in adjusting and optimising pharmaceutical and biological properties such as flow characteristics, dissolution rate and bioavailability.

Particles of the desired particle size for inhalation therapy are conventionally prepared by milling or micronisation. These processes, depending on the precise conditions adopted, are capable of generating particle distributions which include fractions having particles with the appropriate size. Milling is suitable for preparing particles of the larger size indicated above and micronisation of the smaller size indicated above. However, there are a number of disadvantages associated with milling and micronisation processes including that the fraction having the desired particle size may be relatively small, that there may be generated a significant fraction of particles that are finer than is desired (which may be deleterious e.g. if it affects bioavailability) and that product losses generally may be considerable (e.g. through coating of the machinery). A further property of micronised products is that the surfaces of the particles generated are generally substantially amorphous (i.e. have minimal crystallinity). This may be undesirable when there exists a tendency for the amorphous regions to convert to a more stable crystalline state. Furthermore micronised or milled products may be more susceptible to moisture uptake than crystalline products. Micronisation and milling processes also suffer from the disadvantages that they are relatively energy intensive and require containment and other measures to avoid the risk of dust explosion.

Rapid precipitation (e.g. by dilution of a solution with an anti-solvent) may give rise to crystalline particles which could be of suitable size, however this technique is notoriously difficult to control and has not found widespread acceptance in the pharmaceutical industry, particularly in relation to inhalation products.

The use of ultrasonic radiation to increase effectiveness of crystallisation in purification of organic substances is described in Yurhevich, et al. (1972), Primen. Ul'trazvuka Met. Protsessakh, Mosk. Inst. Stali Splavov 67, 103-106.

International patent application PCT/GB99/04368 (filed but not published before the priority date of this application) describes a process and apparatus for preparing particles which comprises mixing in the presence of ultrasonic radiation a flowing solution of a substance in a liquid solvent with a flowing liquid antisolvent for said substance. However, a disadvantage of this process is that it is ineffective when the substance comprises a salt which is essentially insoluble in the solvent. We have now invented an improvement to this process which is less susceptible to the above mentioned disadvantage.

International patent application PCT/EP01/01041 (filed but not published before the priority date of this application) describes a specific process for preparing the calcium salt of (2S)-2-{[(Z)-1-methyl-3-oxo-3-phenyl-1-propenyl]amino}-3-{4-[2-(5-methyl-2-phenyl-1,3-oxazol-4-yl)ethoxy]phenyl}propanoic acid which comprises mixing a solution of said substance as the acid in isopropanol with a solution of calcium chloride or calcium acetate in water in the presence of ultrasonic radiation.

Thus according to a first aspect of the invention there is provided a process for preparing crystalline particles of a salt of a substance which comprises mixing in a continuous flow cell in the presence of ultrasonic radiation a flowing solution of the substance in a liquid solvent with a flowing liquid antisolvent for the salt of said substance, said anti-solvent having dissolved therein the corresponding counter-ion for said salt of substance, and collecting the resultant crystalline particles of salt of substance generated, with the proviso that the process does not comprise mixing a solution of (2S)-2-{[(Z)-1-methyl-3-oxo-3-phenyl-1-propenyl]amino}-3-{4-[2-(5-methyl-2-phenyl-1,3-oxazol-4-yl)ethoxy]phenyl}propanoic acid in isopropanol as solvent with a solution of calcium chloride or calcium acetate in water as antisolvent.

Preferably the liquid anti-solvent is miscible with the liquid solvent.

A particular advantage of the process is that it is capable of running continuously (subject to adequate supply of solution and anti-solvent) even if, for a particular application, it may be desired to run it only for a relatively short time. Also since the process is an essentially “wet” process it significantly reduces hazards associated with dry particulate matter.

A feature of the process is that in a steady state the concentration of dissolved substance in the mixing chamber of the flow cell remains approximately constant since the precipitating substance is replaced by the inflow of further solution. This allows the process to be run continuously and reproducibly.

We have found that the process according to the invention is capable of being very efficient and economical with product yields of up to 95-98%. Apparatus suitable for preparing crystalline particles of a salt of a substance according to the present invention comprises:

(i) a first reservoir of said substance dissolved in a liquid solvent;

(ii) a second reservoir of liquid antisolvent for said salt of substance, said anti-solvent having dissolved therein the corresponding counter-ion for said salt of substance;

(iii) a mixing chamber having first and second inlet ports and an outlet port;

(iv) means for delivering the contents of the first and second reservoirs to the mixing chamber via the first and second inlet ports respectively at independent controlled flow rate;

(v) a source of ultrasonic radiation located in the vicinity of the first inlet; and

(vi) means for collecting crystalline particles of salt of substance suspended in the liquid discharged from the mixing chamber at the outlet port.

Preferably the apparatus further comprises means to mix the liquids delivered to the mixing chamber via the first and second inlets. The preferred means is a stirrer. Most preferably the mixing means should be non grinding e.g. a non-grinding magnetic stirrer or an overhead stirrer (particularly a non-grinding magnetic stirrer).

Desirably, stirring speed will be set at a level that gives efficient mixing in the mixing chamber, but without inducing vortex effects. Vortex effects are undesirable since they have a tendency to disrupt the cavitation caused by the source of ultrasonic radiation. Furthermore they may cause particle size reduction through liquid micronisation-like processes.

Desirably the means for delivering the contents of the first and second reservoirs to the mixing chamber via the first and second inlet ports respectively at independent controlled flow rate comprises one or more pumps. Preferably a pump will be provided for each of the first and second reservoirs. A range of pumps are available and may be suitable for the apparatus according to the invention. The pump may, for example, be a peristaltic pump. Pumps which are essentially non-pulsing are preferred. The contents of the first and second reservoirs may be delivered to the mixing chamber at a range of flow rates which will be selected and optimised according to the nature of the substance, the salt of the substance, the solvent, the antisolvent and the power and frequency of the source of ultrasonic radiation. The solubility of the salt of substance in the solvent relative to the anti-solvent is a particularly important variable. The lower this ratio is, the lower may be the flow rate of anti-solvent relative to the substance/solvent solution. Usually the flow rate of the anti-solvent will exceed that of the solvent solution, the excess typically being ≧2:1 e.g. up to 10:1. Typically flow rates will be in the range of 0.5-100 ml/min especially 0.5-50 ml/min. Higher flow rates of anti-solvent have a tendency to result in crystalline particles of smaller mean size.

Another important variable is the ratio of the concentration of counter-ion in the anti-solvent to substance in the solvent. The concentration of counter-ion in the anti-solvent will generally exceed that of the substance in the solvent, although this need not necessarily be so if the flow rate of anti-solvent is significantly higher than that of the solvent. However in concentration terms a ratio of being ≧2:1 e.g. up to 10:1 may be considered suitable.

Preferably the outlet port of the apparatus is disposed above the inlet ports in the mixing chamber such that the liquid in the mixing chamber flows from a lower to a higher point in the chamber before exiting. This arrangement optimises mixing and allows ready balance of the rates of inflow and outflow.

Preferably the mixing chamber is substantially circular in section and the first and second inlet ports are disposed diametrically opposite each other and at the same height relative to the base of the mixing chamber. Nevertheless, it may be conceived to orientate the two inlet ports in an off-set manner in order to give some circular motion to the inflowing liquids, although this is not generally preferred.

The position of the outlet port relative to the inlet ports is believed to have an influence on the size of the crystalline particles generated. Without being limited by theory, it is believed that the greater the distance between the inlet ports and outlet port, the greater the average residence time of the particles in the flow cell, the longer the crystalline particles have to mature and hence the larger the mean particle size. However it will be appreciated that mean particle size is subject to a number of other influences.

Preferably the exit port is located approximately half way up the side of the mixing chamber.

In one particular embodiment of the invention, the apparatus according to the invention is provided with a number of optional outlet points at different heights relative to the inlet port. Fractions of differing particles size may then be “tapped” from the different outlet ports.

The mixing chamber may be manufactured from a range of conventional materials however these will preferably be selected so as to be unreactive with the substance, the solvent or the anti-solvent. The mixing chamber may be of any suitable size, whether of a size suitable for bench-scale preparation, industrial pilot scale preparation or industrial manufacturing scale. Substance throughputs are a function of the substance, salt of substance, the concentrations of substance and counter-ion and the flow rates.

Particles suspended in the liquid discharged from the mixing chamber at the outlet port may be collected by means of one of a number of conventional particle capturing techniques e.g. filtration or centrifugation.

According to one preferred embodiment, the process of collecting and harvesting the suspended particles will comprise the steps of

(a) filtering the suspension of crystalline particles in the solvent/anti-solvent mixture in order to remove the solvent/antisolvent mixture;

(b) washing the filtered particles with anti-solvent;

(c) resuspending the filtered and washed particles in anti-solvent;

(d) cooling the resultant suspension of filtered, washed and resuspended particles in the anti-solvent; and

(e) collecting crystalline particles by removal of the antisolvent from the cooled suspension.

Preferably, the suspension of crystalline particles in the solvent/anti-solvent mixture will be filtered using a wide range of suitable filters known to persons skilled in the art. Examples of filters include sinters (e.g. glass sinters), fibre filters (e.g. paper and nitrocellulose filters) and membrane filters. We have found that a particularly advantageous filtration arrangement involves use of a glass fibre microfilter sandwiched between two Whatman paper filters (e.g. Whatman 54 filters). The particle size of the filter will be appropriate for the product collected. It is possible to modify the distribution of particles at the fine end by selecting a filter size which allows fines to pass through the filter. Preferably, the filter will be a filter suitable to retain crystalline particles of between 1 and 10 μm, most preferably less than 5 μm, especially less than 3 μm.

It will be appreciated that the anti-solvent used in washing step (b) and resuspension step (c) does not need to be the same anti-solvent that is used in the original process which generates the crystalline particles. Preferably, however, the anti-solvent used in washing step (b) and resuspension step (c) will be the same anti-solvent as is used in the original process.

Preferably, the suspension of crystalline particles obtained in step (d) will be cooled to freezing point. Also preferably, the suspension of crystalline particles obtained in step (a) will be cooled to freezing point using a solid carbon dioxide cooling bath containing a suitable solvent eg. acetone, IMS or methanol.

Where possible, the antisolvent will preferably be water. Preferably, in step (d) the removal of the antisolvent from the cooled suspension is achieved by freeze drying.

According to an alternative preferred embodiment, when the solvent is more volatile than the antisolvent (eg. when the solvent is acetone and the antisolvent is water) we prefer that the process comprises the step of removing the solvent from the solvent/antisolvent mixture prior to collection of the crystalline particles.

Preferably the step of removal of solvent does not give rise to removal of antisolvent to an appreciable extent. More preferably the solvent and anti-solvent are removed in separate (e.g. sequential) steps.

Preferably, the step of removing the solvent is achieved by distillation at or below atmospheric pressure, especially vacuum distillation.

Alternatively, the step of removing the solvent from the solvent/anti-solvent mixture prior to collection of the crystalline particles comprises the step of:

(a) distillation of the suspension of crystalline particles in the solvent/anti-solvent mixture at or below atmospheric pressure in order to remove the solvent;

and the step of collection of the crystalline particles comprises the steps of:

(b) cooling the resultant suspension of crystallisation particles in the anti-solvent; and

(c) collecting crystalline particles by removal of the antisolvent from the cooled suspension.

It will be appreciated that the solvent removal step refers to the removal of a significant proportion of the solvent from the solvent/antisolvent mixture.

Preferably, all or substantially all solvent is removed. The benefits of the invention are expected to be greatest when solvent is removed to the greatest extent.

Preferably, in step (b) the suspension of crystalline particles obtained in step (a) will be cooled to freezing point. Also preferably, in step (b) the suspension of crystalline particles obtained in step (a) will be cooled to freezing point using a solid carbon dioxide cooling bath containing a suitable solvent eg. acetone, IMS or methanol.

Where possible, preferably the antisolvent will be water. Preferably, in step (c) the removal of the antisolvent from the cooled suspension is achieved by freeze drying.

Generally, before use it may be desirable to sieve the dried product softly through a course sieve to remove soft aggregates without effecting size reduction of the primary particles.

Ultrasound frequencies above around 20 kHz are generally suitable; frequencies in the range 20-25 kHz are particularly suitable, especially 22 kHz. Lower frequencies than these are generally to be avoided since they may fall within a range audible to the human ear. For a given geometry of mixing chamber, certain frequencies may be prone to cancellation. Generally this phenomenon may be avoided by modest tuning of the probe frequency. Ultrasound power in the range 5-5000 W may be suitable (although we are not aware of any theoretical upper limit); in general smaller particles are obtainable using higher power.

The source of ultrasonic radiation will be located sufficiently close to the first inlet port such that it efficiently aids induction of precipitation of particles of substance by causing cavitation in the mixing liquids. Preferably the source is located just above the first inlet port. The source preferably includes an ultrasound probe (or perhaps more than one probe). However wrap-around geometries may also be contemplated e.g. wherein ultrasound transducers transmit ultrasonic radiation through pipes. In one such contemplated arrangement the contents of the first and second reservoir are delivered to a Y-shaped junction through inlet arms and one or more ultrasound transducers are attached to the outside of the exit arm. The source of ultrasonic radiation may be enclosed in a protective jacket (e.g. one made of glass) containing a sono-radiation transmission fluid (e.g. silicone or olive oil).

A suitable process for preparing crystalline particles of a salt of substance according to the present invention comprises

(i) delivering the contents of the first and second reservoirs to the mixing chamber via the first and second inlet ports respectively at independent controlled flow rate;

(ii) supplying ultrasonic radiation to the vicinity of the first inlet; and

(iii) collecting the crystalline particles suspended in the liquid discharged from the mixing chamber at the outlet port.

The process is particularly suitable for preparing particles of salts of substances which are pharmaceutical or carrier substances suitable for inhalation therapy.

Examples of pharmaceutical substances useful in inhalation therapy suitable for preparation according to the present invention include the following substances: salmeterol, salbutamol, (2R,3R,4S,5R)-2-[6-Amino-2-(1S-hydroxymethyl-2-phenyl-ethylamino)-purin-9-yl]-5-(2-ethyl-2H-tetrazol-5-yl)-tetrahydro-furan-3,4-diol, (2S)-3-[4-({[4-(Aminocarbonyl)-1-piperidinyl]carbonyl}oxy)phenyl]-2-[((2S)-4-methyl-2-{[2-(2-methylphenoxy)acetyl]amino}pentanoyl)amino]propanoic acid, pirbuterol, fenoterol, reproterol, terbutaline, formoterol and ipratropium.

The process is particularly suitable for preparing particles of salts of substances which are pharmaceutical or carrier substances suitable for oral administration.

Examples of orally administered pharmaceutical substances suitable for preparation according to the present invention include the following substances: (2S)-2-{[(Z)-1-methyl-3-oxo-3-phenyl-1-propenyl]amino}-3-{4-[2-(5-methyl-2-phenyl-1,3-oxazol-4-yl)ethoxy]phenyl}propanoic acid and naratriptan (eg. as hydrochloride) and other 5HT-1 agonists such as sumatriptan (eg. as succinate). Another compound of interest is (3S) tetrahydro-3-furanyl (1S,2R)-3-[[(4-aminophenyl)sulfonyl](isobutyl)amino]-1-benzyl-2-(phosphonooxy)propylcarbamate.

Pharmaceutical substances as described above include asymmetric molecules which may exist as mixtures of optical isomers (e.g. as racemates) or as purified single enantiomers.

When the substance is salmeterol we prefer that the counter-ion is xinafoate.

When the substance is salbutamol we prefer that the counter-ion is sulphate

When the substance is (2R,3R,4S,5R)-2-[6-Amino-2-(1S-hydroxymethyl-2-phenyl-ethylamino)-purin-9-yl]-5-(2-ethyl-2H-tetrazol-5-yl)-tetrahydro-furan-3,4-diol we prefer that the counter-ion is maleate.

When the substance is (2S)-3-[4-({[4-(Aminocarbonyl)-1-piperidinyl]carbonyl}oxy)phenyl]-2-[((2S)-4-methyl-2-{[2-(2-methylphenoxy)acetyl]amino}pentanoyl)amino] propanoic acid we prefer that the counter-ion is potassium.

When the substance is (2S)-2-{[(Z)-1-methyl-3-oxo-3-phenyl-1-propenyl]amino}-3-{4-[2-(5-methyl-2-phenyl-1,3-oxazol4-yl)ethoxy]phenyl}propanoic acid we prefer that the counter-ion is calcium.

When the substance is pirbuterol we prefer that the counter-ion is acetate.

When the substance is fenoterol we prefer that the counter-ion is bromide in order to produce the hydrobromide salt.

When the substance is reproterol we prefer that the counter-ion is chloride in order to produce the hydrochloride salt.

When the substance is terbutaline we prefer that the counter-ion is sulphate.

When the substance is formoterol we prefer that the counter-ion is fumarate.

When the substance is ipratropium we prefer that the counter-ion is bromide.

When the substance is naratriptan we prefer that the counter-ion is chloride in order to produce the hydrochloride salt.

When the substance is (3S) tetrahydro-3-furanyl (1S,2R)-3-[[(4-aminophenyl)sulfonyl](isobutyl)amino]-1-benzyl-2-(phosphonooxy)propylcarbamate we prefer that the counter-ion is calcium.

It is within the scope of the invention that the substance is a mixture of substances. The counterion employed might be the same for each component of the mixture, or different. In order to yield the same salt of each component of the mixture, or different salts of each component of the mixture, or a salt of some components of the mixture and not others, some components of the mixtures may not be susceptible to salt formation at all, eg. esters. One mixture of substances of particular interest is a mixture of fluticasone propionate and salmeterol.

Although it may be preferred to use the substance in the form of its free base or free acid in solution in the solvent it is also possible to use a soluble salt of the substance in solution in the solvent. The crystalline particles are thereby generated through a process of salt exchange. For acid substances soluble salts often include sodium and potassium salts. Insoluble salts (i.e. salts suitable for use as the counter-ion) often include calcium and magnesium salts. For basic substances soluble salts often include acetate salts. Insoluble salts (i.e. salts suitable for use as the counter-ion) often include hydrochloride and tosylate salts.

The solvent and antisolvent liquids will be selected so as to be appropriate for the substance and the salt of substance. Preferably, they are readily miscible in the proportions employed. Suitable combinations of solvent/antisolvent include acetone/water, ethanol/IPA, methanol/IPA, methanol/water, DMF/water, DMAc/water, DMSO/water and reciprocal pairs. Methanol/IPE is also a suitable pairing.

1,1,1,2-tetrafluoroethane (HFA134a) and 1,1,1,2,3,3,3-heptafluoro-n-propane (HFA227) are also potential solvents or antisolvents which may be paired e.g. with ethanol. However the use of these gases in liquefied form would require the use of cold or pressurised equipment.

For generation of small particles by the process according to the invention, it is preferred that the difference between the dissolution properties of the solvent and anti-solvent be as great as possible. For reasons of industrial efficiency (particularly in order to reduce the throughput volumes of liquid) it is preferred to use concentrations of substance in solvent which are as high as possible. Nevertheless the solutions must be stable and not prone to crystallisation before discharge into the continuous flow cell. With this end in mind, it may be preferred to use the solution of the substance in the solvent at elevated temperature. It may also be preferable to cool the anti-solvent.

In order to prevent premature precipitation of the dissolved substance in the lines it will generally be desired to prime the apparatus by first pumping it with solvent. It may be preferred to prime the apparatus by pumping it with heated solvent, particularly when the dissolved substance is close to its solubility limit.

The counterion will be provided in a form (eg. a salt form) which is soluble in the antisolvent. Preferably, a highly soluble form of the counterion is employed so as to minimise the possible extent of precipitation of the counterion other than as associated with the substance. For example, a calcium counterion may be employed as calcium chloride or calcium acetate both of which are freely soluble in water (which is a generally preferred antisolvent). Magnesium is suitably also provided as the chloride or acetate. Chloride, sulphate, xinafoate, maleate, bromide, fumarate and acetate may suitably be provided as the corresponding acid or, preferably, as a sodium or potassium salt.

As a further aspect of the invention we provide a population of particles obtainable by a process according to the invention.

Particles of pharmaceutical or carrier substances may be obtained which are suitable for use in a pharmaceutical composition for inhalation therapy, such as dry powder composition (whether containing pure drug, or drug mixed with a carrier such as lactose) or a pressurised liquid formulation (e.g. a formulation comprising a hydrofluoroalkane propellant such as HFA134a or HFA227).

Pressurised liquid formulations suitable for metered-dose inhalers will be retained in canisters, typically aluminium canisters (which may be plastics lined) which are provided with a metering valve of appropriate metering volume.

It will be appreciated that references to inhalation therapy also extend to administration of pharmaceutical compositions via the nasal route. Formulations suitable for nasal delivery include pressurised (e.g. HFA containing) formulations and non pressurised (e.g. aqueous) formulations which may be metered by the delivery device adapted for administration to the nose.

We also provide a pharmaceutical composition comprising a population of particles prepared according to the invention.

The advantages that the invention may possess include the fact that the process may be performed in a continuous manner without requirements for batch processing, that process may be scaled up with relative ease and that the apparatus and process are capable of producing particle size distributions of very high uniformity index. Certain embodiments of the invention have particular benefits in terms of maintaining the original particle diameter of the particles of substance achieved by crystallisation. When the particles are prepared for inhalation therapy, crystal growth is disadvantageous because the particles may grow to a diameter such that they may not be effectively delivered to the lower respiratory airways.

Apparatus suitable for use in the present invention is illustrated by reference to FIG. 1 in which mixing chamber 1 is provided with first inlet port 2 connected to first reservoir 3 containing substance dissolved in solvent and second inlet port 4 connected to second reservoir 5 containing anti-solvent. Pumps 6 and 7 deliver liquid from reservoirs 3 and 5 to mixing chamber 1 at a controlled rate. An ultrasound probe 8 is located in the vicinity of, and just above, inlet port 2. When pumps 6 and 7 are in operation, liquids from reservoirs 3 and 5 are delivered to mixing chamber 1 and are mixed with the aid of magnetic stirrer 9. Liquid containing the particles of substance thus generated flows out of the mixing chamber via exit port 10 where they are collected by means of filter 11.

### BRIEF DESCRIPTION OF THE DRAWINGS

FIG. 1: Example apparatus according to the invention

The present invention may be illustrated by the following non-limiting Example:

### EXAMPLES

### Example 1

### Preparation of the Calcium Salt of (2S)-2-{[(Z)-1-methyl-3-oxo-3-phenyl-1-propenyl]amino}-3-{4-[2-(5-methyl-2-phenyl-1,3-oxazol-4-yl)ethoxy]phenyl}propanoic Acid

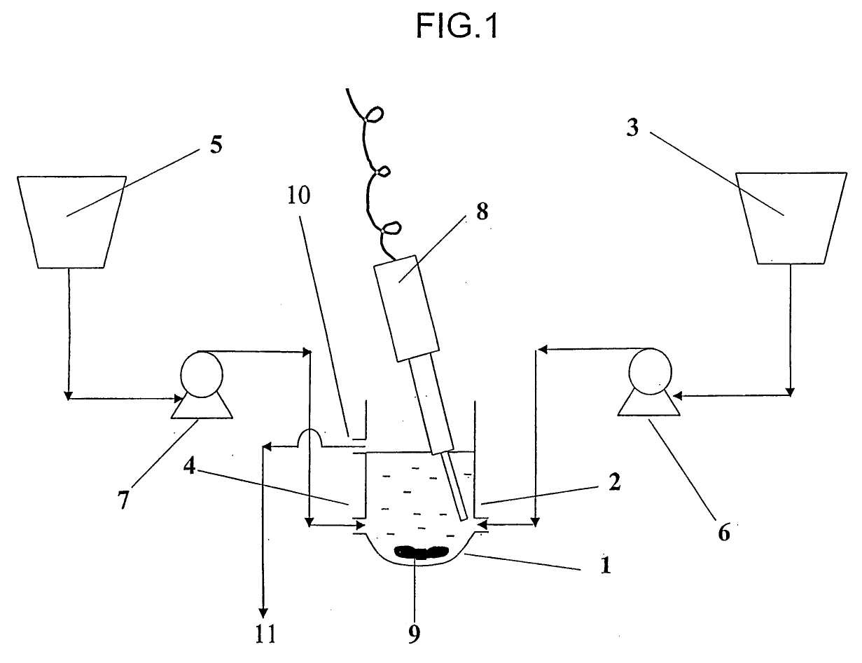

The calcium salt of (2S)-2-{[(Z)-1-methyl-3-oxo-3-phenyl-1-propenyl]amino}-3-{4-[2-(5-methyl-2-phenyl-1,3-oxazol-4-yl)ethoxy]phenyl}propanoic acid was prepared under sonocrystallisation conditions using the apparatus shown in FIG. 1. Using the sonocrystallisation apparatus shown, a solution of calcium chloride (0.55 g) in water (30 ml) and (2S)-2-{[(Z)-1-methyl-3-oxo-3-phenyl-1-propenyl]amino}-3-{4-[2-(5-methyl-2-phenyl-1,3-oxazol-4-yl)ethoxy]phenyl}propanoic acid (prepared according to Example 1 of WO 00/08002) (5.0 g) in isopropanol (60 ml) were pumped into the reaction cell at a rate so as to maintain a 2:1 stoichiometry between the two compounds whilst being sonocrystallised. The slurry was collected on a filter under continuous flow conditions. The filter cake was washed with water and then diisopropyl ether to give an easily handleable solid. This dried to give 4.5 g of crystalline (by XRPD of the calcium salt of (2S)-2-{[(Z)-1-methyl-3-oxo-3-phenyl-1-propenyl]amino}-3-{4-[2-(5-methyl-2-phenyl-1,3-oxazol-4-yl)ethoxy]phenyl}propanoic acid as the monohydrate (confirmed by TGA).

The experiment was repeated using calcium acetate. Again a solution of calcium acetate (0.90 g) in water (30 ml) and (2S)-2-{[(Z)-1-methyl-3-oxo-3-phenyl-1-propenyl]amino}-3-{4-[2-(5-methyl-2-phenyl-1,3-oxazol-4-yl)ethoxy]phenyl}propanoic acid (5.0 g) in isopropanol (60 ml) were pumped into the reaction cell at such a rate so as to maintain a 2:1 stoichiometry between the two components whilst being sonocrystallised. The sample was again identified as a crystalline monohydrate (XRPD, TGA).

Particle size of the two samples were measured using a Malvern Particle Sizer S. The (v0.5) values are as shown below:

Sample 1 D(v,0.5)=32.2 microns

Sample 2 D(v,0.5)=42.3 microns

Throughout the specification and the claims which follow, unless the context requires otherwise, the word ‘comprise’, and variations such as ‘comprises’ and ‘comprising’, will be understood to imply the inclusion of a stated integer or step or group of integers but not to the exclusion of any other integer or step or group of integers or steps.

The contents of the above mentioned patent applications is herein incorporated by reference.

1. A process for preparing crystalline particles of a salt of a substance which comprises mixing in a continuous flow cell in the presence of ultrasonic radiation a flowing solution of the substance in a liquid solvent with a flowing liquid antisolvent for the salt of said substance, said anti-solvent having dissolved therein the corresponding counter-ion for said salt of substance, and collecting the resultant crystalline particles of salt of substance generated, with the proviso that the process does not comprise mixing a solution of (2S)-2-{[(Z)-1-methyl-3-oxo-3-phenyl-1-propenyl]amino}-3-{4-[2-(5-methyl-2-phenyl-1,3-oxazol-4-yl)ethoxy]phenyl}propanoic acid in isopropanol as solvent with a solution of calcium chloride or calcium acetate in water as antisolvent.

2. A process according to claim 1 wherein the liquid antisolvent is miscible with the liquid solvent.

3. A process according to claim 1 or claim 2 wherein collecting and harvesting the suspended particles comprises:
(a) filtering the suspension of crystalline particles in the solvent/anti-solvent mixture in order to remove the solvent/antisolvent mixture;
(b) washing the filtered particles with anti-solvent;
(c) resuspending the filtered and washed particles in anti-solvent;
(d) cooling the resultant suspension of filtered, washed and resuspended particles in the anti-solvent; and
(e) collecting crystalline particles by removal of the antisolvent from the cooled suspension.

4. A process according to claim 3 wherein the step of removing the solvent from the solvent/anti-solvent mixture prior to collection of the crystalline particles comprises:
(a) distillation of the suspension of crystalline particles in the solvent/anti-solvent mixture at or below atmospheric pressure in order to remove the solvent;
and the step of collection of the crystalline particles comprises the steps of:
(b) cooling the resultant suspension of crystallisation particles in the anti-solvent; and
(c) collecting crystalline particles by removal of the antisolvent from the cooled suspension.

5. A process according to any one of claims 1 to 4 wherein the substance is a pharmaceutical or carrier substance suitable for inhalation therapy.

6. A process according to claim 5 wherein the substance suitable for inhalation therapy includes one or more of the following substances: salmeterol, salbutamol, (2R,3R,4S,5R)-2-[6-Amino-2-(1S-hydroxymethyl-2-phenyl-ethylamino)-purin-9-yl]-5-(2-ethyl-2H-tetrazol-5-yl)-tetrahydro-furan-3,4-diol, (2S)-3-[4-({[4-(Aminocarbonyl)-1-piperidinyl]carbonyl}oxy)phenyl]-2-[((2S)-4-methyl-2-{[2-(2-methylphenoxy)acetyl]amino}pentanoyl)amino]propanoic acid, pirbuterol, fenoterol, reproterol, terbutaline, formoterol and ipratropium.

7. A process according to claim 1 wherein the substance is a pharmaceutical or carrier substance suitable for oral administration.

8. A process according to claim 7 wherein the substance suitable for oral administration includes one or more of the following substances: (2S)-2-{[(Z)-1-methyl-3-oxo-3-phenyl-1-propenyl]amino}-3-{4-[2-(5-methyl-2-phenyl-1,3-oxazol-4-yl)ethoxy]phenyl}propanoic acid and naratriptan.

9. A process according to claim 6 wherein the substance is salmeterol and the counter-ion is xinafoate.

10. A process according to claim 6 wherein the substance is salbutamol and the counter-ion is sulphate.

11. A process according to claim 6 wherein the substance is (2R,3R,4S, 5R)-2-[6-Amino-2-(1S-hydroxymethyl-2-phenyl-ethylamino)-purin-9-yl]-5-(2-ethyl-2H-tetrazol-5-yl)-tetrahydro-furan-3,4-diol and the counter-ion is maleate.

12. A process according to claim 6 wherein the substance is (2S)-3-[4-({[4-(Aminocarbonyl)-1-piperidinyl]carbonyl}oxy)phenyl]-2-[((2S)-4-methyl-2-{[2-(2-methylphenoxy)acetyl]amino}pentanoyl)amino]propanoic acid and the counterion is potassium.

13. A process according to claim 7 wherein the substance is naratriptan and the counter-ion is chloride.

14. A process according to any one of claims 1 to 13 wherein the substance is a mixture of substances.

15. A population of particles obtainable by a process according to any one of claims 1 to 14.

16. A pharmaceutical composition comprising a population of particles according to claim 15.

17. Apparatus suitable for preparing crystalline particles of a salt of a substance according to any one of claims 1 to 14 which comprises:
(i) a first reservoir of said substance dissolved in a liquid solvent;
(ii) a second reservoir of liquid antisolvent for said salt of substance, said antisolvent having dissolved therein the corresponding counter-ion for said salt of substance;
(iii) a mixing chamber having first and second inlet ports and an outlet port;
(iv) means for delivering the contents of the first and second reservoirs to the mixing chamber via the first and second inlet ports respectively at independent controlled flow rate;
(v) a source of ultrasonic radiation located in the vicinity of the first inlet; and
(vi) means for collecting crystalline particles of salt of substance suspended in the liquid discharged from the mixing chamber at the outlet port.
